(19) United States
(12) Patent Application Publication
(10) Pub. No.: US 2022/0010963 A1
(43) Pub. Date: Jan. 13, 2022

(54) Non-Electric Portable Heating Apparatus and Associated Methods

(71) Applicant: Jared Kazee, Palm Bay, FL (US)

(72) Inventor: Jared Kazee, Palm Bay, FL (US)

(21) Appl. No.: 17/486,598

(22) Filed: Sep. 27, 2021

Related U.S. Application Data
(60) Provisional application No. 63/084,026, filed on Sep. 28, 2020.

(51) Int. Cl. F24C 1/16; F24C 9/00; A47J 36/28

(52) U.S. Cl. CPC F24C 1/16; A47J 36/28; F24C 9/00

(57) ABSTRACT

A non-electric heating apparatus with an upper and lower section. The upper section includes a cupholder and surrounding upper reaction chamber with dry reaction materials therein. The lower section includes a lower housing, a lower outer shell with lower outer shell apertures, a lower inner shell with lower inner shell apertures, a lower reaction chamber with dry reaction materials surrounding the lower housing, a platform within the lower housing, a bladder containing water on the platform, and bottom. The platform is movable within the housing and the lower outer apertures are structured to rotatably align with the lower inner apertures. Water may be expelled from the bladder into the upper reaction chamber when the platform is moved within the lower housing. The upper reaction chamber produces an exothermic reaction when water enters. The lower reaction chamber creates an exothermic reaction when airflow enters through the aligned inner and outer apertures.

### RELATED APPLICATIONS

This application claims the benefit under 35 U.S.C. § 119(e) of U.S. Provisional Patent Application Ser. No. 63/084,026 titled “Non-Electric Portable Heating Apparatus and Associated Methods” filed on Sep. 28, 2020, the entire contents of which are incorporated herein by reference.

### FIELD OF THE INVENTION

The present invention relates to systems and methods for portably heating food and beverages. In particular, the present invention relates to a portable device for heating food and beverages without electricity.

### BACKGROUND

In 2020 the world was plagued with the outbreak of the coronavirus pandemic. With quarantine restrictions in place people began seeking solace in outdoor activities like camping. Campers with little to no experience found themselves venturing into the wild for recreation. Without experience in creating campfires to warm their food and beverages, many campers either didn't make campfires or irresponsibly created them putting nature and others at risk.

In addition to campers, many people desire to have a warm beverage when they are without the luxury of electricity. This happens on everyday commutes, walks, and other common types of travel. There exists a need in the art for a portable, quick and easy means to heat a food or beverage without using electricity or fire. There also exists a need to keep the food or beverage under continued heat for extended enjoyment. Therefore, there is a need for a non-electric portable heating apparatus and associated methods.

This background is provided to reveal information believed by the applicant to be of possible relevance to the present invention. No admission is made as to prior art and nothing within the background should be construed as prior art against the present invention.

### BRIEF DESCRIPTION OF THE DRAWINGS

FIG. 1A is a bottom perspective view of the non-electric portable heating apparatus according to an embodiment of the invention.

FIG. 1B is a top perspective view of the non-electric portable heating apparatus illustrated in FIG. 1A.

FIG. 2 is a cross sectioned perspective view of the non-electric portable heating apparatus according to an embodiment of the invention.

FIG. 2A is a cross sectioned perspective view of interior componentry of the non-electric portable heating apparatus according to an embodiment of the invention.

FIG. 2B is a sectional view of a lower portion of the non-electric portable heating apparatus according to an embodiment of the invention.

FIG. 2C is a top perspective view of a lower outer shell component of the non-electric portable heating apparatus according to an embodiment of the invention.

FIG. 2D is a perspective view of interior componentry of the non-electric portable heating apparatus in a first position according to an embodiment of the invention.

FIG. 2E is a perspective view of interior componentry of the non-electric portable heating apparatus in a second position according to an embodiment of the invention.

FIG. 2F is a perspective view of interior componentry of the non-electric portable heating apparatus in a first position according to an embodiment of the invention.

FIG. 2G is a perspective view of interior componentry of the non-electric portable heating apparatus in a second position according to an embodiment of the invention.

FIG. 2H is a cross sectioned perspective view of the non-electric portable heating apparatus with internal componentry in a first position according to an embodiment of the invention.

FIG. 2I is a cross sectioned perspective view of the non-electric portable heating apparatus with internal componentry in a second position according to an embodiment of the invention.

FIG. 3A is a cross-sectioned view of the non-electric portable heating apparatus according to an embodiment of the invention.

FIG. 3B is a cross-sectioned view of the non-electric portable heating apparatus according to an embodiment of the invention.

FIG. 3C is a cross-sectioned view of the non-electric portable heating apparatus according to an embodiment of the invention.

FIG. 3D is a cross-sectioned view of the non-electric portable heating apparatus according to an embodiment of the invention.

FIG. 4A is a front view of the non-electric portable heating apparatus in a first position according to an embodiment of the invention.

FIG. 4B is a front view of the non-electric portable heating apparatus in a second position according to an embodiment of the invention.

FIG. 5A is a cross-sectioned perspective environmental view of the non-electric portable heating apparatus according to an embodiment of the invention.

FIG. 5B is a cross-sectioned perspective environmental view of the non-electric portable heating apparatus according to an embodiment of the invention.

### SUMMARY OF THE INVENTION

Embodiments of the invention are directed to a non-electric portable heating apparatus including an upper section, a lower section, and a bottom. The upper section may include an upper void and an upper reaction chamber surrounding the upper void including dry reaction materials. The lower section may include a lower housing, a lower outer shell with lower outer shell apertures, a lower inner shell with lower inner shell apertures, a lower reaction chamber with dry mixture reaction materials surrounding the lower housing, a platform within the lower housing, at least one bladder containing water positioned on the platform, and a bottom.

The platform may be movable longitudinally within the housing and the lower outer shell apertures may be structured to rotatably align with the lower inner shell apertures. The bladder may be structured to expel water into the upper reaction chamber when the platform is moved longitudinally within the lower housing. The upper reaction chamber may be structured to produce an exothermic reaction when water enters the upper reaction chamber. The lower reaction chamber may be structured to allow air to flow therein when the lower outer shell apertures and the lower inner shell apertures are aligned. The lower reaction chamber may be structured to create an exothermic reaction when the lower outer shell apertures and the lower inner shell apertures are aligned and airflow enters the lower reaction chamber.

In some embodiments, one section of the lower housing may include a serrated grate configured to puncture the at least one bladder when brought in contact therewith. The grate may include cells structured to channel waterflow to the upper reaction chamber.

The upper reaction chamber may include a dry reaction mixture structured to create an exothermic reaction with water. Similarly, the lower reaction chamber may include a mixture structured to create an exothermic reaction with air.

In some embodiments, the lower outer shell apertures may form at least one of an image, shape, design, and logo. The platform ay be structured to move longitudinally within the bladder housing along a platform axis. Furthermore, the platform may be structured to move longitudinally within the bladder housing when the bottom is rotated thereby rotating the platform axis and actuating the platform via medial threading within a medial platform aperture.

Another embodiment may include a non-electric portable heating apparatus including an upper section, a lower section, and a bottom. The upper section may include an upper void and an upper reaction chamber surrounding the upper void including dry reaction materials. The lower section may include a lower housing, a lower outer shell with lower outer shell apertures, a lower inner shell with lower inner shell apertures, a lower reaction chamber surrounding the upper void including reaction materials, a platform with a platform aperture within the lower housing, at least one bladder containing water positioned on the platform, a platform axis extending the longitudinal length of the lower housing, a serrated grate separating the upper section and the lower section, and a bottom.

The platform may be movable longitudinally within the housing along the platform axis. The lower outer shell apertures may be structured to rotatably align with the lower inner shell apertures. The at least one bladder may be structured to be punctured by the serrated grate expelling water into the upper reaction chamber when the platform is moved longitudinally and pressed against the serrated grate. The upper reaction chamber may be structured to produce an exothermic reaction with water when water enters the upper reaction chamber. The lower reaction chamber may be structured to allow air to flow therein when the lower outer shell apertures and the lower inner shell apertures are aligned.

In this embodiment, the upper reaction chamber may include a dry mixture structured to create an exothermic reaction when mixed with water. The lower reaction chamber may include a mixture configured to create an exothermic reaction when mixed with air. The dry mixture reaction materials may be enclosed by a thin porous membrane. Furthermore, the at least one bladder may be doughnut shaped with a central hole that encircles the platform axis.

The platform may be structured to move longitudinally along the platform axis when the bottom is rotated thereby rotating the platform axis and translating the platform via threading within the platform aperture. The platform may be structured to move longitudinally along the platform axis when a user applies external force to the apparatus bottom. In some embodiments, the at least one bladder is a plurality of bladders containing water.

Another embodiment of the invention may include a non-electric portable heating apparatus including an upper section, a lower section, and a bottom. The upper section may include an upper void and an upper reaction chamber surrounding the upper void including dry reaction materials. The lower section may include a lower housing, a lower outer shell with lower outer shell apertures, a lower inner shell with lower inner shell apertures, a lower reaction chamber surrounding the upper void including reaction materials, a platform within the lower housing, a plurality of stoppers within the lower housing, a bladder containing water positioned on the platform with a bulbous base, a spout, a bladder tip with slits forming pie shaped flaps, and an apparatus bottom.

The platform may be movable longitudinally within the housing. The lower outer shell apertures may be structured to rotatably align with the lower inner shell apertures. The bladder tip and a portion of the spout may be fixed within the upper reaction chamber and the bladder may be structured to expel water into the upper reaction chamber when the platform is moved longitudinally within the lower housing and the bulbous portion of the bladder is compressed against the plurality of stoppers. The upper reaction chamber may be structured to produce an exothermic reaction when water enters the upper reaction chamber and the lower reaction chamber may be structured to allow air to flow therein when the lower outer shell apertures and the lower inner shell apertures are aligned. The lower reaction chamber may be structured to create an exothermic reaction when the lower outer shell apertures and the lower inner shell apertures are aligned and airflow enters.

In this embodiment, the lower outer shell apertures may form at least one of an image, shape, design, and logo. The platform may be structured to move longitudinally within the lower housing when a user applies external force to the apparatus bottom. Additionally, the upper and lower reaction materials may be enclosed within a thin porous membrane configured to allow water and air to permeate therethrough.

### DETAILED DESCRIPTION OF THE INVENTION

The present invention will now be described in detail with reference to the accompanying drawings. The embodiment descriptions are illustrative and not intended to be limiting in any way. Other embodiments of the invention will readily suggest themselves to persons with ordinary skill in the art after having the benefit of this disclosure. Accordingly, the following embodiments are set forth without any loss of generality and without imposing limitation upon the claimed invention.

Directional terms such as “above” “below” “upper” “lower” and other like terms are used for the convenience of the reader in reference to the drawings. Additionally, the description may contain terminology to convey position, orientation, and direction without departing from the principles of the present invention. Such positional language should be taken in context of the represented drawings.

Quantitative terms such as “generally” “substantially” “mostly” and other like terms are used to mean that the referred object, characteristic, or quality constitutes a majority of the referenced subject. Likewise, use of the terms such as first and second do not necessarily designate a limitation of quantity. Such terms may be used as a method of describing the presence of at least one of the referenced elements or may provide a means of differentiating orientation. The meaning of any term within this description is dependent upon the context within which it is used, and the meaning may be expressly modified.

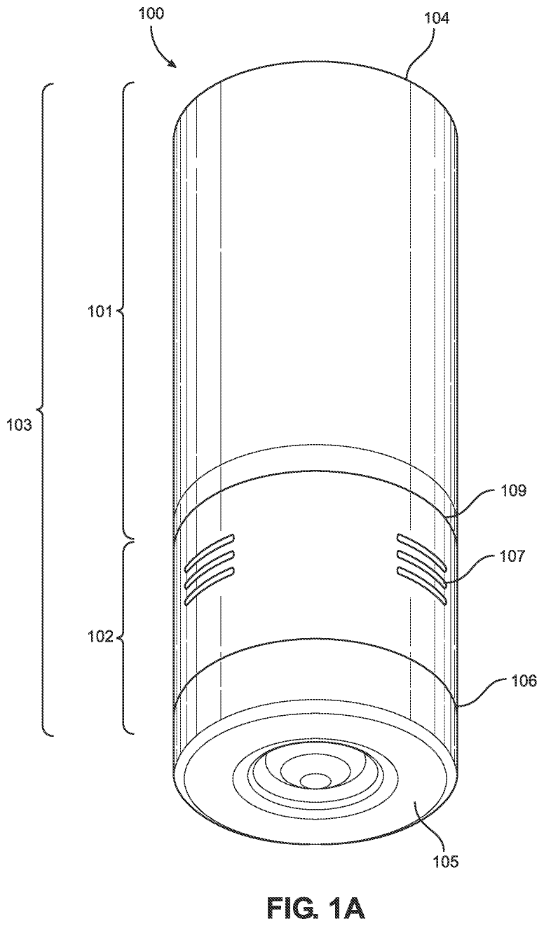

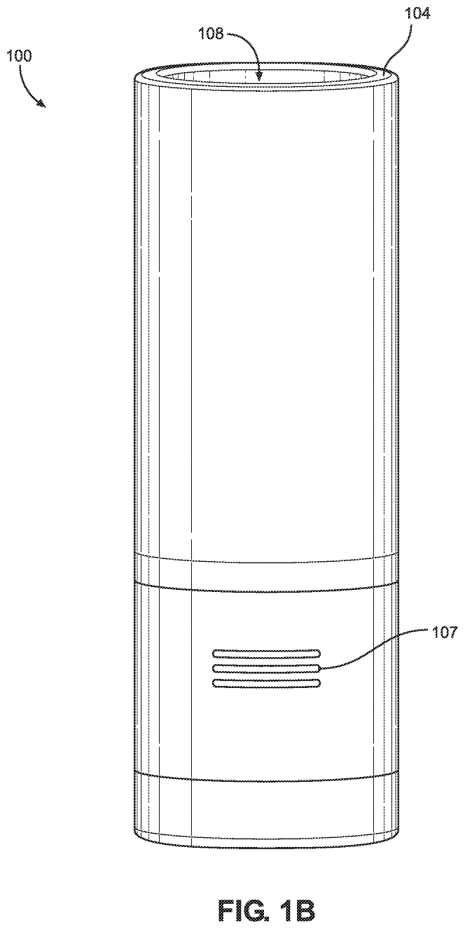

Referring to FIGS. 1A and 1B, a non-electric portable heating apparatus, hereinafter the apparatus 100, will be described in more detail. The apparatus 100 may include an upper section 101, a lower section 102, and apparatus outside shell 103. It may also include a top 104 with top aperture 108 and a bottom 105. Medially located on the apparatus 100 may be a bifurcating midsection 109 that may split the apparatus 100 into the upper section 101 and lower section 102. The term bifurcating midsection 109 is not to be construed as limiting any embodiment to two equal halves. In some embodiments, the apparatus 100 may be divided between a larger upper section 101 and a smaller lower section 102 or vice versa.

Within the outside shell 103 at the lower section 102 may be lower outer shell apertures 107. In some embodiments the lower outer shell apertures 107 may be ventilation holes structured as grouped horizontal openings. In some embodiments this may resemble three rectangular or oval horizontal openings stacked on top of each other. However, one skilled in the art will appreciate that the lower outer shell apertures 107 may be structed as square, circular, oval, triangular, polygonal, a cluster of holes, or the like. In some embodiments the lower outer shell apertures 107 may be a cluster of holes forming a particular image, shape, design or logo.

The apparatus 100 may also include a seal 106 around the apparatus outside shell 103 proximate the bottom 105. In some embodiments the seal 106 may be a removable means to secure the lower section 102 to the bottom 105.

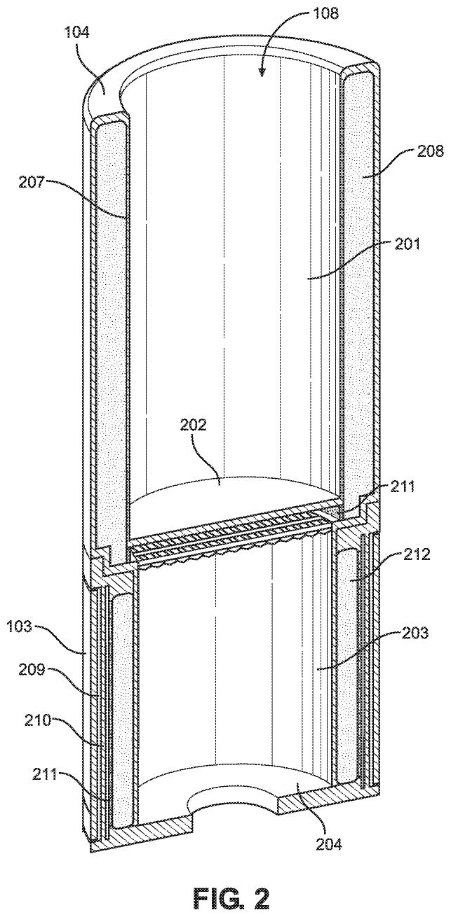

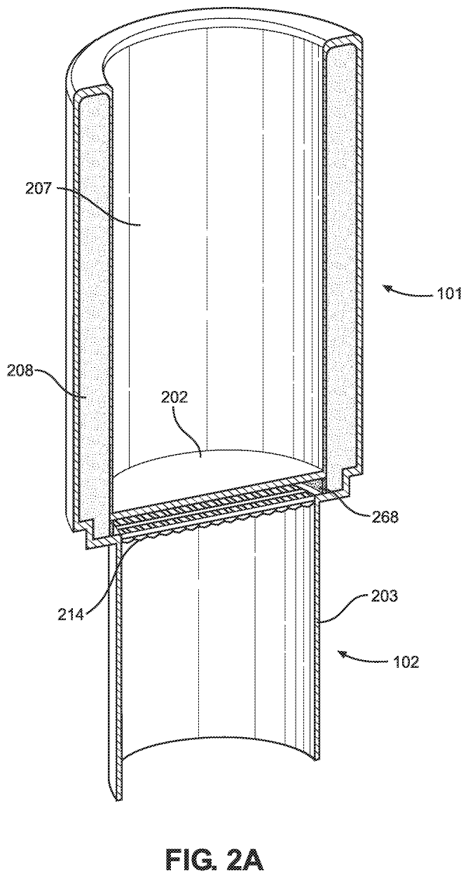

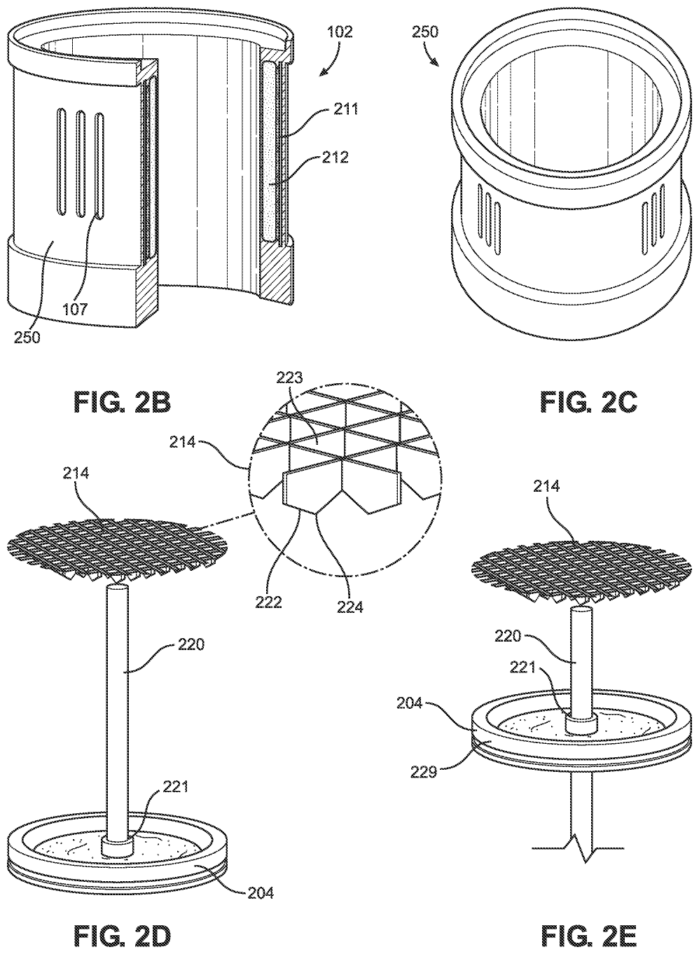

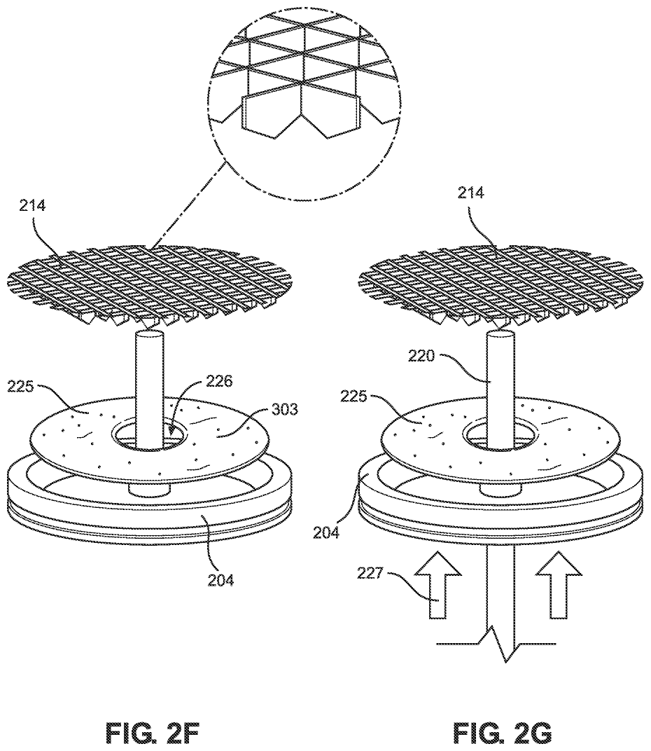

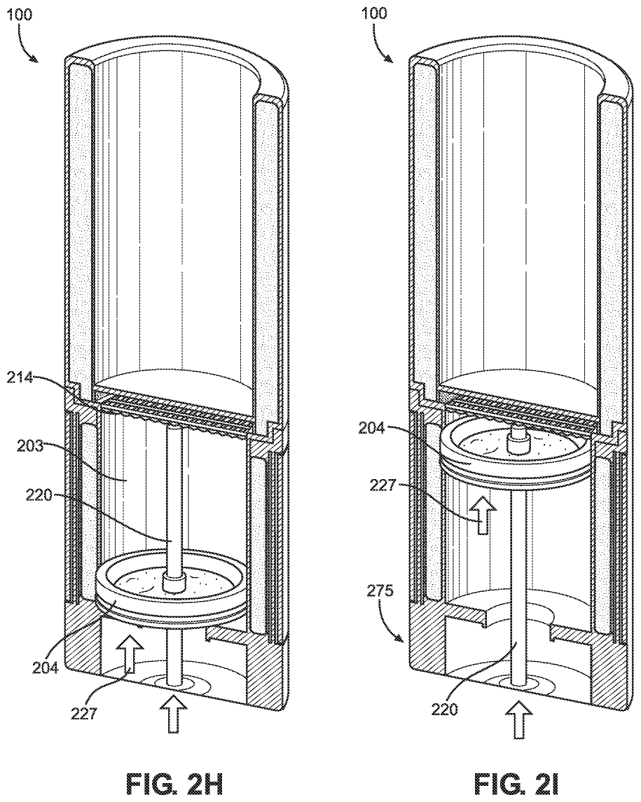

FIG. 2 shows a cross sectioned view of the apparatus 100 demonstrating the layered componentry therein. As shown, the apparatus 100 may include an upper void that may be a cupholder 201 within the upper section 101 defined by a cupholder shell 207 that may extend from the top 104 at the top aperture 108 to a bottom plate 202. Between the cupholder shell 207 and interior walls of the apparatus shell 103 may be an upper reaction chamber 208. The upper reaction chamber 208 may be a cavity in the upper section 101 structured to accommodate reaction materials therein.

Extending from the bifurcating midsection 109 below the upper section 101 may be a bladder housing 203. The bladder housing 203 may be a shell within the lower section 102 of the apparatus 100 that may extend from the bifurcating midsection 109 to a bladder platform 204. Surrounding the bladder housing 203 may be a lower reaction chamber 212 structured to contain lower reaction material therein.

As shown, in some embodiments the lower section 102 may include an apparatus shell 103 containing the lower outer shell apertures 107. It may include a small space 209 between the lower outer shell 103 and an inner vented layer 210 more central to the apparatus. This small space 209 may be structured to minimize friction and allow for the lower outer shell 103 to move around the inner vented layer 210. In some embodiments, a thin porous membrane 211 may surround an interior of the lower reaction chamber 212, which may allow for reaction materials to be contained within the chamber without escaping from the ventilation apertures. The porous nature of the porous membrane 211 may allow for air to enter the membrane and react with its contents without having the reaction materials prolapse. However, some embodiments may not include the porous membrane 211 and reaction materials may simply be housed within the lower reaction chamber 212.

The bladder platform 204 may be a supportive bottom to the bladder housing 203 and in some embodiments may be structured to slide longitudinally within the bladder housing 203.

FIG. 2A illustrates that the upper section 101 and the bladder housing 203 of the lower section 102 may be a single unit. Therefore, the cupholder shell 207 with upper reaction chamber 208 may form the upper section 101 of the apparatus. The bladder housing 203 may be formed as a continuation of the outer shell 103 of the upper section 101. The bottom plate 202 may be positioned atop an upper portion of the lower section 102 and below the bottom plate may be a water entry cavity 268. Just below the water entry cavity 268 and forming an upper boundary to the bladder housing 203 may be a serrated grate 214.

FIG. 2B illustrates a cross section of the lower section 102 of the apparatus 100. In particular, this figure emphasizes the lower outer shell apertures 107 on the lower outer shell 250. It also demonstrates that in some embodiments the lower reaction chamber 212 may include and be circumscribed by the thin porous membrane 211 enabling air to flow into the lower reaction chamber 212, but not allowing the contents of the lower reaction chamber 212 to escape.

FIG. 2C illustrates that the lower section 102 of the apparatus 100 may be circumscribed by the lower outer shell 250. In some embodiments, the lower outer shell 250 may be a separate sleeve that fits overtop and around the bladder housing 203. Therefore, the lower outer shell 250 as depicted in this figure may wrap around the lower section depicted in FIG. 2A.

FIGS. 2D and 2E are perspective views of interior componentry of the non-electric portable heating apparatus in a first and second position according to an embodiment of the invention. More particularly, these figures illustrate that the bladder platform 204 may be connected to a medial platform axis 220 extending from the bladder platform 204 to the serrated grate 214. By way of non-limiting example, the platform axis 220 may be an elongate cylindrical member. The bladder platform 204 may include a platform aperture 221 enabling the bladder platform 204 to slidably engage the platform axis 220. Thus, the bladder platform 204 may slide longitudinally along the platform axis 220 from the apparatus bottom 105 to the serrated grate 214.

FIG. 2D further illustrates the serrated grate 214 itself. The serrated grate 214 may include a plurality of cells 223 whereby at least one surface includes sharp edges 222 with downward points 224. In some embodiments the plurality of cells 223 may be structured to channel waterflow to the upper reaction chamber 208. Furthermore, in some embodiments the serrated grate 214 may be sized with a diameter that is slightly smaller than the bladder platform 204. Additionally, the bladder platform 204 may include an outer ridge 229 at its perimeter. The serrated grate 214 may be sized to fit within the outer ridge 229 of the bladder platform 204.

FIGS. 2F and 2G illustrate a bladder 225 filled with water 303 resting on the bladder platform 204. In some embodiments, the bladder 225 may be doughnut shaped with a central hole 226 that fits around the platform axis 220. In other embodiments, there may be a plurality of bladders 225 surrounding the platform axis 220. Furthermore, in some embodiments, the bladder 225 may include an adhesive allowing it to secure to the bladder platform 204 without prolapsing. In either embodiment, the bladder platform 204 may transport the bladder 225 from being held within the bladder housing 203 to being pressed against the serrated grate 214.

FIGS. 2H and 2I illustrate the upward motion 227 of the bladder platform as it is being used within the apparatus 100. FIG. 2H shows the bladder platform 204 in a first position proximate the bottom 105 of the apparatus 100. As upward force is applied from the bottom 105, the bladder platform 204 may move upward along the platform axis 220 to deliver the bladder platform 204 to the serrated grate 214.

FIG. 2I illustrates the bladder platform 204 in a second position as it is being pressed against the serrated grate 214. In some embodiments, a bottom section 275 of the apparatus 100 may be rotatable causing the platform axis 220 to rotate due to threading on the platform axis 220. In this embodiment, the threading of the platform axis 220 in relation to threading within the platform aperture 221 may allow for the bladder platform 204 to move longitudinally along the platform axis 220 when the bottom section 275 is actuated or acted upon by a user. In other words, threading within the platform aperture 221 may be designed to accommodate threading on the platform axis 220 therethrough. The threaded platform aperture 221 may coordinate with the threading of the platform axis 220 to enable bladder platform 204 to ascend and descend the bladder housing 203.

In other embodiments, a user may simply press against the bottom 105 of the apparatus 100 and manually force the bladder platform 204 into the serrated grate 215. In some embodiments the bladder platform 204 may not host a bladder 225 at all. Instead, the bladder platform 204 may simply act as a plunger applying pressure to the bladder housing 203 that may be filled with liquid. Once force is applied to the bottom 105 of the bladder platform 204 in this embodiment, that pressure is applied against the liquid contained within the bladder housing 203. This pressure alone may cause for the unenclosed water to be forced into the upper section 101.

However, in other embodiments the apparatus 100 may not include the bottom section 275 and the bladder platform 204 may serve as the bottom 105 of the apparatus 100. In this embodiment, when a user applies force to the bottom 105, they are actuating the bladder platform 204 directly and forcing either the bladder 225 into the serrated grate 214 or an empty chamber filled with water toward the upper section 101.

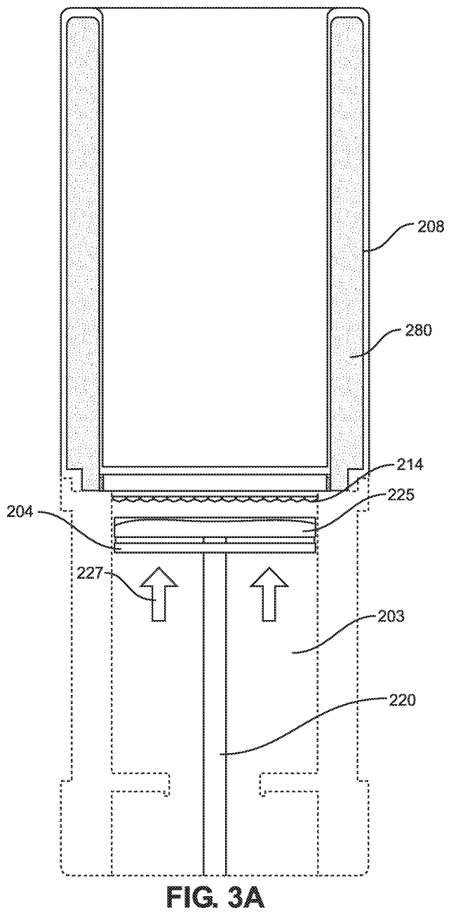

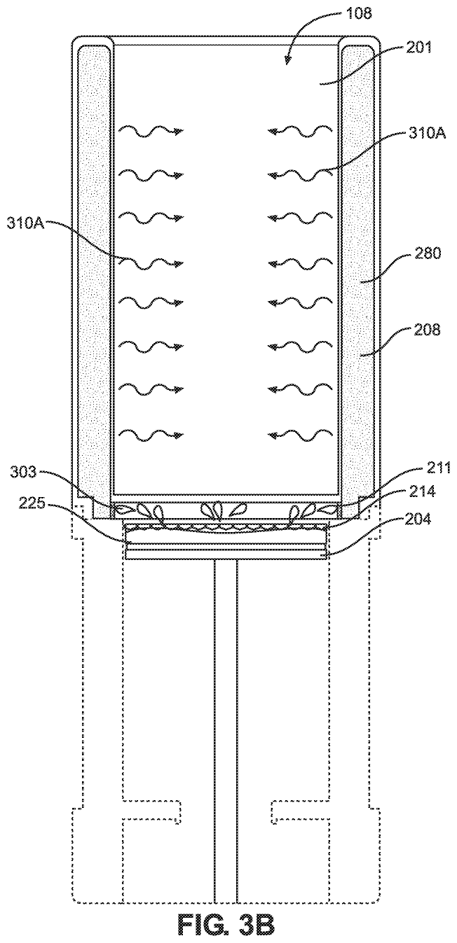

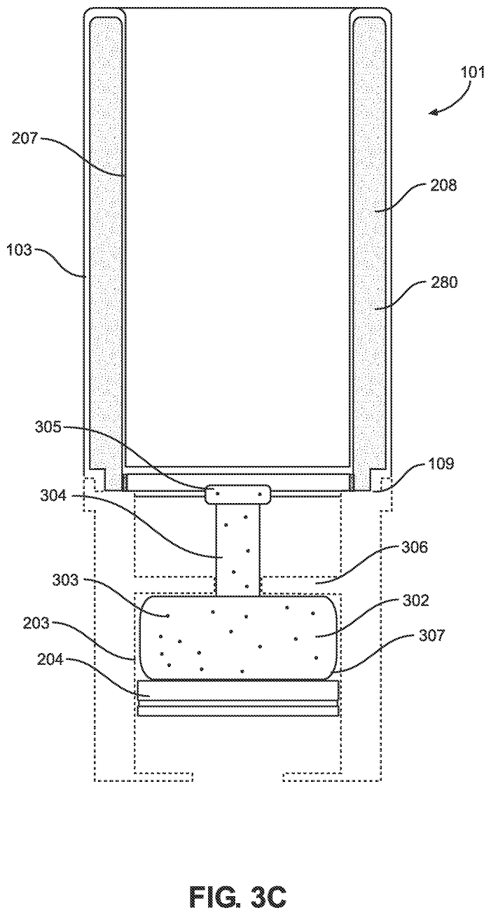

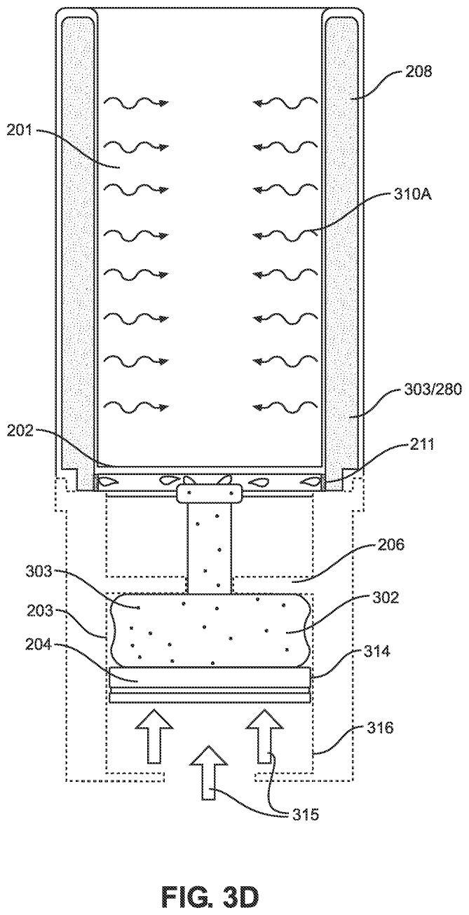

FIGS. 3A and 3B illustrate an embodiment whereby the bladder 225 is atop the bladder platform 204. The bladder platform 204 is being actuated and moved along the platform axis 220 toward the serrated grate 214. In this embodiment, the bladder 225 may be a thin membraned sack encasing water or a plurality of thin membraned sacks encasing water 303. As FIG. 3B shows, when the bladder platform 204 is actuated to the point where it is forced against the serrated grate 214, the thin membraned bladder 225 is punctured and the water 303 contained therein is forced into the upper reaction chamber 208 and reacts with the first dry mixture 280 within the upper reaction chamber 208. An exothermic reaction between the water 303 and the first dry mixture 280 creates heat 310 that permeates through the exterior of the cupholder 201 to warm it.

FIG. 3C like the embodiment described in FIGS. 3A and 3B includes the upper reaction chamber 208 filled with a first dry mixture 280. In some embodiments, the first dry mixture 280 may include calcium chloride.

Also depicted is a different type of bladder 302 that may be used with the apparatus 100. This bladder 302 may be structured with a bulbous base portion 307 that may contain water 303. Attached to the bulbous base portion 307 may be a spout 301, which may be an elongated neck extending from the bulbous base portion 307 to a bladder tip 305. In some embodiments, the bladder tip 305 and a portion of the spout 304 may be fixed within the upper reaction chamber 208.

The bladder tip 305 may include slits that in some embodiments may be crossed to form pie-shaped flaps within the bladder tip 305. The pie-shaped flaps may be rigid enough to prevent water 303 from unintentionally entering the upper reaction chamber 208. However, the slits in conjunction with the pie-shaped flaps may be structured to allow water 303 to flow from the bladder 302 into the upper reaction chamber 208 when proper force is applied to the underside of the bladder 302.

FIG. 3D shows externally applied force 315 being directed to the underside of the bladder platform 204. This may occur when a user pushes the bladder platform 204 from the bottom 105 of the apparatus 100 toward the bifurcating midsection 109. The bladder platform 204 may slidably transition from its initial position within a housing channel 316. As the externally applied force 315 is continually directed toward the underside of the bladder platform 204, the bladder 302 is compressed as it is squeezed against stoppers 206. When the bladder 302 is squeezed, water 303 may exit the bladder tip 305 through the slits and prolapsed pie-shaped flaps and enter the upper reaction chamber 208.

When the water 303 enters the upper reaction chamber 208, a water-mixture combination 311 creates an exothermic reaction causing heat 310a to warm the upper section 101 and the cupholder 201.

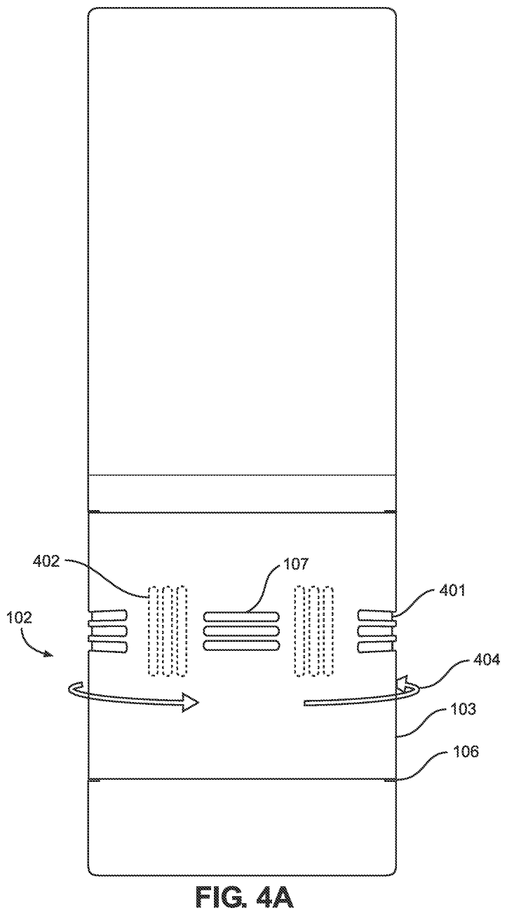

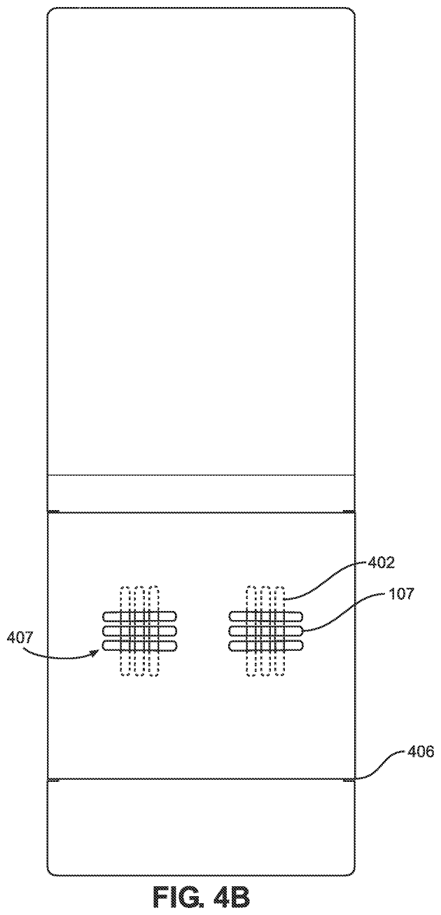

FIGS. 4A and 4B illustrate some of the functional features of the lower section 102 of the apparatus 100. As previously mentioned, within the apparatus outside shell 103 may be lower outer shell apertures 107. However, the lower section 102 may also contain a lower section inner shell 401 nominally distanced from the inside walls of the apparatus outside shell 103. The lower section inner shell 401 may include inner shell apertures 402 that may be equivalently sized and shaped to the lower outer shell apertures 107. However, in some embodiments the size and shape of the inner shell apertures 402 and the lower outer shell apertures 107 may be different. One skilled in the art will appreciate that both sets of apertures may be structured to allow for the flow of air external to the apparatus to pass through both sets of apertures and flow to an interior portion of the apparatus 100.

In the embodiment illustrated in FIG. 4A, the lower outer shell apertures 107 are shown as three horizontally stacked cylindrical apertures. Similarly, the inner shell apertures 402 are depicted as three vertically aligned cylindrical apertures staggered and interior from the lower outer shell apertures 107.

Again, one skilled in the art will appreciate that both the inner shell apertures 402 and the lower outer shell apertures 107 may be any number of shapes and configurations depending on need, preference and circumstance. By way of non-limiting example, they may be structed as square, circular, oval, triangular, polygonal, a cluster of holes, or the like. In some embodiments they may be a cluster of holes forming a particular image, shape, design or logo.

The lower section 102 of the apparatus 102 may be structured so that the apparatus outside shell 103 may turn 404 in a clockwise or counterclockwise motion to align the lower outer shell apertures 107 with the inner shell apertures 402. This turn 404 may be achieved due to threading along the lower section 102 of the apparatus 100. Furthermore, when the apparatus outside shell 103 at the lower section 102 is twisted it may break the seal 106.

FIG. 4B demonstrates an apparatus 100 with a broken seal 407 as well as the outer shell apertures 403 aligned with the inner shell apertures 402 and locked into position 407. When locked into this position 407, the aligned apertures form a tunnel allowing outside air to enter the lower section 102 of the apparatus 100. Before being turned 404, air is prevented from entering the lower section 102 of the apparatus 100 because the lower outer shell apertures 107 are aligned with a solid portion of the lower section inner shell 401.

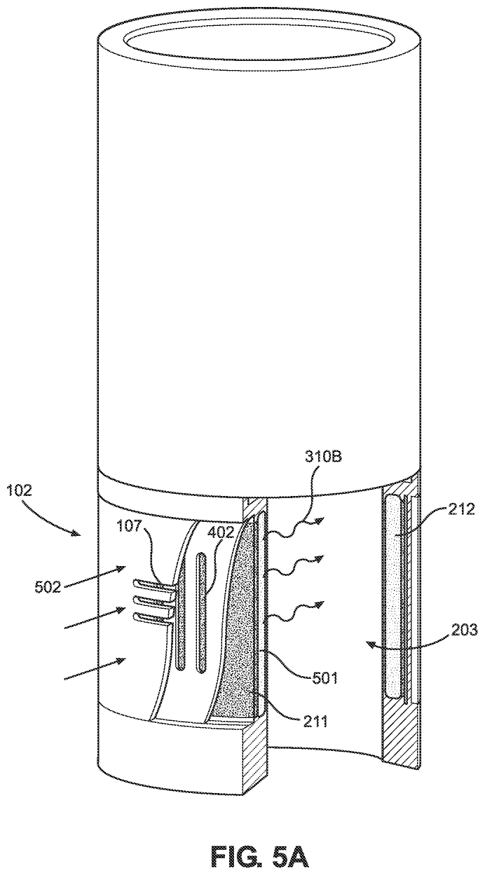

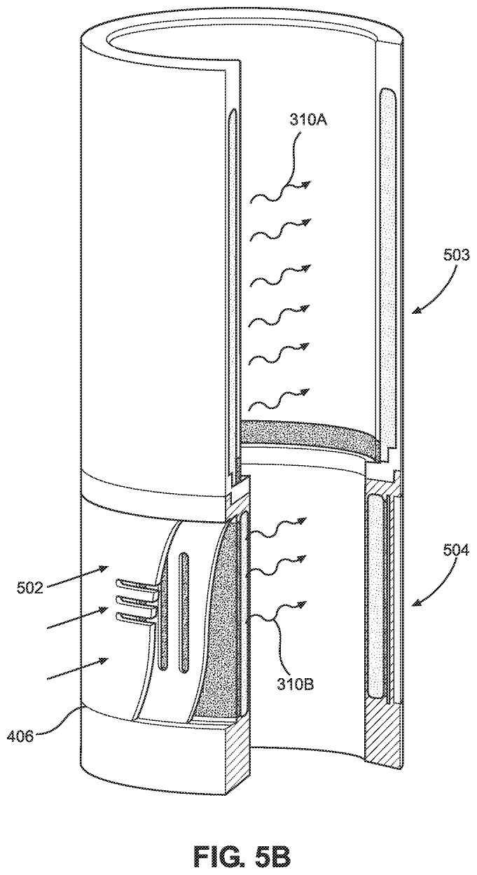

FIG. 5A illustrates a lower reaction chamber 510 between the lower section inner shell 401 and the bladder housing 203. The lower reaction chamber 510 may be filled with a second dry mixture 501. By way of non-limiting example, the second dry mixture 501 may include cellulose, iron, activated carbon, vermiculite and salt. When incoming airflow 502 enters the lower reaction chamber 212 through the aligned outer and inner shell apertures 107, 402 an exothermic reaction causes heat 310b to warm the lower section 102 and upper section 101 including the cupholder 201.

FIG. 5B shows a fully reacted upper chamber 503 and a fully reacted lower chamber 504. A fully reacted upper chamber 503 may produce higher temperatures at a quicker rate than a fully reacted lower chamber 504. However, a fully reacted lower chamber 504 may produce a lower temperature heat for a longer period of time. Therefore, a user may utilize both features to quickly heat the desired contents within the cupholder 201 and keep it at a warm temperature for an extended period of time.

By way of non-limiting example, a user may utilize the device by first activating the upper section 101 heating features. This may be accomplished by the user actuating the bladder platform 204 toward the bifurcating midsection 109. That externally applied force may continue until the bladder platform reaches a position proximate the bifurcating midsection 109 and forces water 303 into the upper reaction chamber 208. This may cause the upper section 101 to quickly produce heat 310a. The user may then place their desired contents within the cupholder 201 for quick heating. Next, the user may break the seal 106 by twisting 404 the apparatus shell 103 at the lower section 102 until the inner and outer shell apertures 402, 107 are aligned. This may cause the lower section 101 to produce heat 310b over an extended period of time. Because the cupholder 201 may be infused with heat conducting material, the cupholder 201 contents will be quickly warmed and remain warm for an extended period of time.

That which is claimed is:

1. A non-electric portable heating apparatus comprising
an upper section comprising
an upper void; and
an upper reaction chamber surrounding the upper void comprising dry reaction materials;
a lower section comprising
a lower housing;
a lower outer shell with lower outer shell apertures;
a lower inner shell with lower inner shell apertures;
a lower reaction chamber comprising dry mixture reaction materials surrounding the lower housing;
a platform within the lower housing;
at least one bladder containing water positioned on the platform; and
a bottom;
wherein the platform is movable longitudinally within the housing;
wherein the lower outer shell apertures are configured to rotatably align with the lower inner shell apertures;
wherein the bladder is configured to expel water into the upper reaction chamber when the platform is moved longitudinally within the lower housing;
wherein the upper reaction chamber is configured to produce an exothermic reaction when water enters the upper reaction chamber;
wherein the lower reaction chamber is configured to allow air to flow therein when the lower outer shell apertures and the lower inner shell apertures are aligned;
wherein the lower reaction chamber is configured to create an exothermic reaction when the lower outer shell apertures and the lower inner shell apertures are aligned and airflow enters the lower reaction chamber.

2. The non-electric portable heating apparatus of claim 1 wherein one section of the lower housing comprises a serrated grate configured to puncture the at least one bladder when brought in contact therewith.

3. The non-electric portable heating apparatus of claim 2 wherein the grate comprises cells configured to channel waterflow to the upper reaction chamber.

4. The non-electric portable heating apparatus of claim 1 wherein the upper reaction chamber comprises a dry mixture configured to create an exothermic reaction with water; and wherein the lower reaction chamber comprises a mixture configured to create an exothermic reaction with air.

5. The non-electric portable heating apparatus of claim 1 wherein the lower outer shell apertures form at least one of an image, shape, design, and logo.

6. The non-electric portable heating apparatus of claim 1 wherein the platform is configured to move longitudinally within the bladder housing along a platform axis.

7. The non-electric portable heating apparatus of claim 6 wherein the platform is configured to move longitudinally within the bladder housing when the bottom is rotated thereby rotating the platform axis and actuating the platform via medial threading within a medial platform aperture.

8. A non-electric portable heating apparatus comprising
an upper section comprising
an upper void; and
an upper reaction chamber comprising dry mixture reaction materials surrounding the upper void;
a lower section comprising
a lower housing;
a lower outer shell with lower outer shell apertures;
a lower inner shell with lower inner shell apertures;
a lower reaction chamber surrounding the upper void comprising reaction materials;
a platform with platform aperture within the lower housing;
at least one bladder containing water positioned on the platform;
a platform axis extending the longitudinal length of the lower housing;
a serrated grate separating the upper section and the lower section; and
a bottom;
wherein the platform is movable longitudinally within the housing along the platform axis;
wherein the lower outer shell apertures are configured to rotatably align with the lower inner shell apertures;
wherein the at least one bladder is configured to be punctured by the serrated grate expelling water into the upper reaction chamber when the platform is moved longitudinally and pressed against the serrated grate;
wherein the upper reaction chamber is configured to produce an exothermic reaction with water when water enters the upper reaction chamber;
wherein the lower reaction chamber is configured to allow air to flow therein when the lower outer shell apertures and the lower inner shell apertures are aligned;
wherein the lower reaction chamber is configured to create an exothermic reaction when the lower outer shell apertures and the lower inner shell apertures are aligned and airflow enters the lower reaction chamber.

9. The non-electric portable heating apparatus of claim 8 wherein the upper reaction chamber comprises a dry mixture configured to create an exothermic reaction when mixed with water.

10. The non-electric portable heating apparatus of claim 8 wherein the lower reaction chamber comprises a mixture configured to create an exothermic reaction when mixed with air.

11. The non-electric portable heating apparatus of claim 9 wherein the dry mixture is enclosed by a thin porous membrane.

12. The non-electric portable heating apparatus of claim 10 wherein the mixture is enclosed by a thin porous membrane.

13. The non-electric portable heating apparatus of claim 8 wherein the at least one bladder is doughnut shaped with a central hole that encircles the platform axis.

14. The non-electric portable heating apparatus of claim 8 wherein the platform is configured to move longitudinally along the platform axis when the bottom is rotated thereby rotating the platform axis and translating the platform via threading within the platform aperture.

15. The non-electric portable heating apparatus of claim 8 wherein the platform is configured to move longitudinally along the platform axis when a user applies external force to the apparatus bottom.

16. The non-electric portable heating apparatus of claim 8 wherein the at least one bladder is a plurality of bladders containing water.

17. A non-electric portable heating apparatus comprising
an upper section comprising
an upper void; and
an upper reaction chamber comprising dry mixture reaction materials surrounding the upper void;
a lower section comprising
a lower housing;
a lower outer shell with lower outer shell apertures;
a lower inner shell with lower inner shell apertures;
a lower reaction chamber surrounding the upper void comprising reaction materials;
a platform within the lower housing;
a plurality of stoppers within the lower housing;
a bladder containing water positioned on the platform comprising
a bulbous base,
a spout,
a bladder tip with slits forming pie shaped flaps; and
a bottom;
wherein the platform is movable longitudinally within the housing;
wherein the lower outer shell apertures are configured to rotatably align with the lower inner shell apertures;
wherein the bladder tip and a portion of the spout are fixed within the upper reaction chamber;
wherein the bladder is configured to expel water into the upper reaction chamber when the platform is moved longitudinally within the lower housing and the bulbous portion of the bladder is compressed against the plurality of stoppers;
wherein the upper reaction chamber is configured to produce an exothermic reaction when water enters the upper reaction chamber;
wherein the lower reaction chamber is configured to allow air to flow therein when the lower outer shell apertures and the lower inner shell apertures are aligned;
wherein the lower reaction chamber is configured to create an exothermic reaction when the lower outer shell apertures and the lower inner shell apertures are aligned and airflow enters the lower reaction chamber.

18. The non-electric portable heating apparatus of claim 17 wherein the lower outer shell apertures form at least one of an image, shape, design, and logo.

19. The non-electric portable heating apparatus of claim 17 wherein the platform is configured to move longitudinally within the lower housing when a user applies external force to the apparatus bottom.

20. The non-electric portable heating apparatus of claim 17 wherein the upper and lower reaction materials are encompassed within a thin porous membrane configured to allow water and air to permeate therethrough.
